(19) United States
(12) Patent Application Publication
(10) Pub. No.: US 2006/0234075 A1
(43) Pub. Date: Oct. 19, 2006

(54) Ink-accepting layer forming material and aqueous ink

(76) Inventor: Kazue Watanabe, Tokyo (JP)

Correspondence Address: JORDAN AND HAMBURG LLP, 122 EAST 42ND STREET, SUITE 4000, NEW YORK, NY, 10168, US

(21) Appl. No.: 10/562,353

(22) PCT Filed: Jun. 24, 2004
(86) PCT No.: PCT/JP04/09345

§ 371 Date: Mar. 27, 2006

(30) Foreign Application Priority Data
Jun. 24, 2003 (JP) 2003-180351

(51) Int. Cl. C09D 5/02; B05D 3/00; B05D 1/02; B05D 1/36; B05D 5/00; B29C 47/00; B05D 1/18; C09B 67/00; B32B 27/30

(52) U.S. Cl. 428/522; 524/13; 524/501; 524/502; 427/299; 427/402; 427/421.1; 427/430.1; 427/256; 428/463; 428/514; 428/442

(57) ABSTRACT

An ink-accepting layer forming material is disclosed which is applied in advance to an ink-accepting surface of an object that is to be colored with an ink containing an anionic coloring material. The ink-accepting layer forming material comprises a weak acidic acrylic aqueous emulsion adhesive obtained by copolymerizing one or more (meth)acrylates having an alkyl group with 4-12 carbon atoms and a vinyl monomer, a water-soluble cationic polymer, and an aqueous medium. The acrylic aqueous emulsion adhesive has a viscosity of 4,000-20,000 mPa.s/30° C. when it is in an emulsion state with about 50% solid content, and a dried film of the acrylic aqueous emulsion adhesive has a glass transition temperature within the range from −10 to −50° C.

### TECHNICAL FIELD

The present invention relates to an ink-accepting layer forming material suitably used for dyeing, printing, painting or the like using ink, an object that is to be colored to which the ink accepting layer forming material is applied, and a coloring method using the object to be colored. The present invention further relates to water-base ink, an article colored using the water-base ink, and a coloring method using the water-base ink.

### BACKGROUND ART

An ink jet printing method has been progressed and extensively put to practical use in the field of printing on paper. However, fabrics, when used for printing, are different from paper in that there are wide variety of material types and roughness of woven cloth, and the upper directionality thereof is conspicuous. Therefore, when the ink jet printing method is applied to dyeing on a fabric, it is difficult to obtain a sharp pattern without feathering and uneven density of ink.

Japanese Laid-Open Patent Publication No. 61-55277 discloses a fabric for ink jet dyeing aiming at prevention of color bleeding. In this fabric for ink jet dyeing, a dye containing 0.1 to 50% by weight of a non-dyeing compound forms a holding layer. This ink retaining layer functions as printing starch used in a general printing method, and dyes a fiber with a dye retained therein. The fiber needs to be subjected to moist heat treatment to fix the dye after printing, then washed to remove excessive dye and the ink retaining layer (non-dyeing compound). Further, since the dyeing and the moist heat treatment for fixing a dye are carried out separately, there is a limitation in obtaining a delicate and sharp pattern formed with fine ink dots.

The fabric for ink jet printing disclosed in Japanese Laid-Open Patent Publication No. 8-100379 improves penetrability of the ink retaining layer by coating a surfactant as a penetrant on the surface of a single fiber of a fabric material before forming the ink retaining layer on the fabric material. However, the ink retaining layer used herein also functions as a general printing starch and a dye therefore needs to be subjected to moist heat treatment after ink jet printing and, at the same time, washing (with water) is required to remove the ink retaining layer, which is printing starch. Further, since the dyeing and the moist heat treatment to fix a dye are carried out separately, there is a limitation in obtaining a delicate and sharp pattern formed with fine ink dots.

An ink jet printing method disclosed in Japanese Laid-Open Patent Publication No. 2000-43244 adds an ink retainer and a treatment liquid composed of a synthetic resin having a glass transition temperature within the range from 60 to 130° C. onto a polyester fabric and carries out moist heat treatment at a temperature of 150 to 190° C. after ink jet printing. Since the synthetic resin having a glass transition temperature within the range from 150 to 190° C. is formed as a film by this moist heat treatment, the texture and flexibility of a fabric per se is greatly deteriorated (hardened), and it is assumed that this fabric is not suitable for a clothe.

On the other hand, many recording materials for ink jet printing wherein an ink-accepting layer is formed on a porous base material such as paper or a fiber have been proposed (refer to Japanese Laid-Open Patent Publication No. 10-182962, Japanese Laid-Open Patent Publication No. 11-180036, Japanese Laid-Open Patent Publication No. 2000-296666, Japanese Laid-Open Patent Publication No. 2001-260523, Japanese Laid-Open Patent Publication No. 2001-353956 or the like). An ink-accepting layer of each of the above recording materials for ink jet printing contains an aqueous polyurethane resin having a glass transition temperature of not less than 20° C. and further contains an inorganic filler, a dye fixing agent or the like. The purpose of using the aqueous polyurethane resin having a glass transition temperature of not less than 20° C. and the inorganic filler is to form an ink-accepting layer which is firm and stable at a room temperature and, when such ink-accepting layer is applied to a fabric used for a clothe, the texture and flexibility of the cloth per se is greatly deteriorated.

Accordingly, an object of the present invention is to provide an ink-accepting layer forming material capable of imparting, when applied in advance to an ink-accepting surface of a base material to be colored with ink (e.g., dyeing, printing or painting), a dyeing property to various types of base materials together with excellent sharpness of an image, waterfastness, climatefastness, and color development of an image, regardless of whether the ink used is dye ink or pigment ink, and moreover, to impart a dyeing property to a soft base material while maintaining the texture and flexibility thereof together with excellent sharpness of an image, waterfastness, climatefastness, and color development.

Another object of the present invention is to provide a water-base ink usable for dyeing, printing, painting or the like on various base materials together with excellent sharpness of an image, waterfastness, climatefastness, and color development, and moreover, for dyeing, printing, painting or the like on soft paper, fabric, hair or the like while maintaining the texture and flexibility thereof together with excellent sharpness of an image, waterfastness, climatefastness and color development.

Other purposes of the present invention will be cleared from the following description.

### DISCLOSURE OF THE INVENTION

In order to attain the above objects, the present invention provides an ink-accepting layer forming material applied in advance to an ink-accepting surface of a base material that is to be colored with ink containing an anionic coloring material. The ink accepting-layer forming material comprises a weak acidic acrylic aqueous emulsion adhesive obtained by copolymerizing one or more ester (meth) acrylates having an alkyl group with 4-12 carbon atoms and a vinyl monomer, a water-soluble cationic polymer, and an aqueous medium. The acrylic aqueous emulsion adhesive has a viscosity of 4,000-20,000 mPa·s/30° C. when it is an emulsion state with about 50% solid content, and a dried film of the acrylic aqueous emulsion adhesive has a glass transition temperature (Tg) within the range from −10 to −50° C.

The ink-accepting layer having the above construction is capable of forming a transparent dried film on the base material to be colored by being applied in advance on the ink-accepting surface of the base material to be colored with ink (e.g., dyeing, printing, or painting), and of imparting dyeing property to various materials together with excellent sharpness of an image, waterfastness, climatefastness and color development, regardless of whether the ink used is dye ink or pigment ink, and moreover, to a soft base material while maintaining the texture and flexibility thereof together with excellent sharpness of an image, waterfastness, climatefastness and color development,.

It is assumed that the water-soluble cationic polymer contained in the ink-accepting layer forming material improves the absorption of emulsion particles of the acrylic adhesive together with improving the adsorption of the anionic coloring material onto the dried film of the acrylic adhesive. The dried film of the ink-accepting layer forming material is effective even when the ink containing the anionic coloring material is water-base ink or when printing is carried out by a laser printer or a color photocopier.

The adsorption of the base material to be colored and the ink to the anionic coloring material is deteriorated resulting in insufficient adhesion or sticking force when the acrylic aqueous emulsion adhesive has a viscosity of not more than 4,000 mPa·s/30° C. or not less than 20,000 mPa·s/30° C. when it is an emulsion state with about 50% solid content. Further, the viscosity of not less than 20,000 mPa·s/30° C. when it is an emulsion state with about 50% solid content causes deterioration of penetrability into the base material to be colored, particularly, into fiber structures such as cloth, paper and leather, and also causes a damage to the flexibility of the cloth in particular. Accordingly, it is more preferable that the viscosity of the acrylic aqueous emulsion adhesive has a viscosity of 10,000-15,000 mPa·s/30° C. when it is an emulsion state with about 50% solid content.

The adsorption of the base material to be colored and the ink to the anionic coloring material is deteriorated resulting in insufficient adhesion or sticking force when the acrylic aqueous emulsion adhesive has either glass transition temperature (Tg) of higher than −10° C. or lower than −50° C. Further, when the glass transition temperature (Tg) of the dried film is higher than −10° C. and cloth is used as a base material to be colored, a dried film formed on the surface of the fiber of the cloth causes deterioration of the texture of the cloth. Further, when the glass transition temperature (Tg) of the dried film is lower than −50° C., the dried film formed on the base material to be colored gives an unpleasant feeling when touched with a hand. Accordingly, it is more preferable that the acrylic aqueous emulsion adhesive has a glass transition temperature (Tg) in a dried film form within the range from −40 to −40° C.

Preferably, the acrylic aqueous emulsion adhesive obtained by copolymerizing one or more ester (meth) acrylates having an alkyl group with 4-12 carbon atoms and a vinyl monomer under presence of a nonionic surfactant or a nonionic surfactant and an anionic surfactant. Even when the acrylic aqueous emulsion adhesive is emulsion-polymerized under presence of a nonionic surfactant or when the acrylic aqueous emulsion adhesive is subjected to emulsion-polymerization under presence of a nonionic surfactant and an anionic surfactant, the mixture of the acrylic aqueous emulsion adhesive and the water-soluble cationic polymer does not generate agglutinate which may be an obstacle in practical use, and the acrylic aqueous emulsion adhesive can maintain sufficient practical dispersibility.

Preferably, the solid content of the acrylic aqueous emulsion adhesive is 0.5 to 5% by weight, the content of the water-soluble cationic polymer is 0.1 to 3% by weight, and the rest is an aqueous medium. When the solid content of the acrylic aqueous emulsion adhesive is more than 5% by weight, penetrability of the emulsion particles into the fiber of cloth, in particular, is deteriorated. When the solid content of the acrylic aqueous emulsion adhesive is less than 0.5% by weight, the number of times the ink-accepting layer forming material is applied to the base material to be colored needs to be inefficiently increased. When the content of the water-base cationic polymer less than 0.1% by weight, the adhesion or sticking force of the coloring material contained in the ink is deteriorated resulting in deterioration of fastness to washing with water and cleaning. On the other hand, when the content of the water-soluble cationic polymer is more than 3% by weight, the content is excessive on the basis of the solid content of the acrylic aqueous emulsion adhesive, and when the base material to be colored is wetted by water after coloring (dyeing, printing, painting or the like), the surplus of the water-base cationic polymer flows out and causes contamination of the environment.

Preferably, the acrylic aqueous emulsion adhesive has the average molecular weight (Mn) within the range from 3,000 to 20,000 and the weight-average molecular weight (Mw) within the range from 10,000 to 100,000.

Preferably, the acrylic aqueous emulsion adhesive has a mean particle diameter within the range from 0.1 to 3 μm as measured by the laser diffusion method.

Preferably, the minimum forming temperature (MFT) of the dried film of the acrylic aqueous emulsion adhesive is not more than 0° C.

Preferably, the acrylic aqueous emulsion adhesive is obtained by emulsion copolymerization of 2-ethylhexyl acrylate, butyl acrylate, and vinyl acetate.

Preferably, the content of the vinyl acetate in the acrylic aqueous emulsion adhesion is 20to 30% by weight on the basis of the whole copolymer.

Preferably, the water-soluble cationic polymer is a copolymer of quaternary ammonium salts.

Preferably, the water-soluble cationic polymer comprises a monoarylamine derivative represented by a general formula CH₂═CH—CH₂—NHR (wherein R represents an alkyl group with 1-18carbon atoms, a substituted alkyl group, an aralkyl group, or a cycloalkyl group) or a polymer of the salts thereof; or a copolymer of the monoarylamine derivative or a polymer of the salts thereof and a monomer having an unsaturated double bond, which is copolymerizable with the above derivative or the polymer.

Preferably, the water-soluble cationic polymer is a polyarylamine hydrochloride having a weight-average molecular weight (Mw) within the range from 1,000 to 5,000.

Preferably, an aqueous emulsion of a weak acidic modified silicon resin with a nonionic or a weak anionic particle charge is added to the ink-accepting layer forming material.

Preferably, an aqueous emulsion of a weak acidic fluorine resin with a nonionic or a weak anionic particle charge is added to the ink-accepting layer forming material.

Preferably, an aqueous emulsion of weak acidic polylactic acid with a nonionic or a weak anionic particle charge.

Preferably, the anionic coloring material has an anionic group, more preferably, the anionic coloring material is at least one selected from the group consisting of a pigment, an inorganic colorant, a direct dye, an acid dye and a reactive dye.

The present invention further provides an object to be colored formed by applying the ink-accepting layer forming material to the ink-accepting surface of the base material to be colored by the ink containing the anionic coloring material to form the dried film of the ink-accepting layer forming material.

The present invention further provides a method of forming the ink-accepting layer forming material by applying the ink-accepting layer forming material to the ink-accepting surface of the base material to be colored by the ink containing the anionic coloring material to form the dried film of the ink-accepting layer forming material, wherein a step of applying the ink-accepting layer forming material to the ink-accepting surface of the base material to be colored to form the dried film of the ink-accepting layer forming material is repeated for a plurality of times.

Preferably, the base material to be colored is selected from the group consisting of a natural or synthetic resin; a natural, synthetic or mixed fiber; cloth formed of a natural, synthetic, or mixed fiber; paper; wood; leather; synthetic leather; glass; a shell; a stone; and a metal. They can be used alone or as a composite material of two or more.

The present invention further provides a coloring method, wherein the object is colored with ink by one method selected from the group consisting of dip dyeing, printing, ink-jet printing, laser printer printing, coating, and spraying.

The present invention further provides water-base ink comprising a weak acidic acrylic aqueous emulsion adhesive obtained by copolymerizing one or more ester (meth)acrylates having an alkyl group with 4-12 carbon atoms, a water-soluble cationic polymer, an anionic coloring material, and an aqueous medium. The acrylic aqueous emulsion adhesive has a viscosity of 4,000-20,000 mPa·s/30° C. when it is an emulsion state with about 50% solid content, and a dried film of the acrylic aqueous emulsion adhesive has a glass transition temperature (Tg) within the range from −10 to −50° C.

Preferably, the acrylic aqueous emulsion adhesive in the water-base ink is obtained by copolymerizing one or more ester (meth) acrylates having an alkyl group with 4-12 carbon atoms under the presence of a nonionic surfactant.

Preferably, the acrylic aqueous emulsion adhesive in the water-base ink is obtained by copolymerizing one or more ester (meth)acrylates having an alkyl group with 4-12 carbon atoms and a vinyl monomer under the presence of a nonionic or anionic surfactant.

Preferably, the solid content of the acrylic aqueous emulsion adhesive in the water-base ink is 0.2 to 3% by weight, the content of the water-soluble cationic polymer is 0.1 to 3% by weight, the content of the anionic coloring material is 1 to 5% by weight, and the rest is an aqueous medium.

Preferably, the acrylic aqueous emulsion adhesive has the average molecular weight (Mn) of the acrylic aqueous emulsion adhesive in the water-base ink within the range from 3,000 to 20,000 and the weight-average molecular weight (Mw) within the range from 10,000 to 100,000.

Preferably, the acrylic aqueous emulsion adhesive in the water-base ink has a mean particle diameter within the range from 0.1 to 3 μm as measured by the laser diffusion method.

Preferably, the minimum film forming temperature (MFT) of the dried film of the acrylic aqueous emulsion adhesive is not more than 0° C.

Preferably, the acrylic aqueous emulsion adhesive is obtained by emulsion copolymerization of 2-ethylhexyl acrylate, butyl acrylate, and vinyl acetate.

Preferably, the content of the vinyl acetate on the basis of the whole copolymer in the acrylic aqueous emulsion adhesion is in the range from 20 to 30% by weight.

Preferably, the water-soluble cationic polymer is a copolymer of a quaternary ammonium salt.

Preferably, the water-soluble cationic polymer comprises a monoarylamine derivative represented by a general formula CH₂═CH—CH₂—NHR (wherein R represents an alkyl group with 1-18 carbon atoms, a substituted alkyl group, an aralkyl group, or a cycloalkyl group) or a polymer of the salts thereof; or a copolymer of the monoarylamine derivative or a polymer of the salts thereof and a monomer having an unsaturated double bond, which is copolymerizable with the above derivative or the polymer.

Preferably, the water-soluble cationic polymer is a polyarylamine hydrochloride having a weight-average molecular weight within the range from 1,000 to 5,000.

Preferably, an aqueous emulsion of weak acidic a modified silicon resin having a nonionic or weak anionic particle charge is added to the ink-accepting layer forming material.

Preferably, an aqueous emulsion of a weak acidic fluorine resin having a nonionic or weak anionic particle charge is added to the water-base ink.

Preferably, an aqueous emulsion of a weak acidic polylactic acid having a nonionic or weak anionic particle charge is added to the water-base ink.

Preferably, the anionic coloring material in the water-base ink has an anionic group, more preferably, the anionic coloring material is at least one selected from the group consisting of a pigment, a functional colorant, a direct dye, an acid dye and a reactive dye.

The present invention further provides an object that is to be colored formed by applying the water-base ink to the ink-accepting surface of the base material to be colored.

Preferably, the base material to be colored for the object to be colored is selected from the group consisting of a natural or synthetic resin; a natural, synthetic, or mixed fiber; cloth formed of a natural, synthetic, or mixed fiber; paper; wood; leather; synthetic leather; glass; a shell; a stone; and a metal. They can be used alone or as a composite material or two or more.

The present invention further provides a coloring method, wherein the ink is applied to the ink-accepting surface of the base material to be colored by one method selected from the group consisting of dip dyeing, printing, ink-jet printing, laser printer printing, coating, and spraying.

Preferably, in the coloring method, the base material to be colored is selected from the group consisting of a natural or synthetic resin; a natural, synthetic, or mixed fiber; cloth formed of a natural, synthetic, or mixed fiber; paper; wood; leather; synthetic leather; glass; a shell; a stone; and a metal. They can be used alone or as a composite material or two or more.

### BEST MODE FOR CARRYING OUT THE INVENTION

Specific examples of the ester (meth)acrylates having an alkyl group with 4-12 carbon atoms used in the present invention include: methyl acrylate, ethyl acrylate, butyl acrylate, 2-ethylhexyl acrylate, hexyl acrylate, heptyl acrylate, octyl acrylate, and octadecyl acrylate. Among them, the 2-ethylhexyl acrylate and the butyl acrylate are perticularly preferably. Further, preferable examples of the vinyl monomers used in the present invention include: stylene, acrylonitryl, methyl methacrylate, vinyl acetate, and vinyl chloride. Among them, the vinyl acetate is particularly preferable.

When, for example, a copolymer of butyl acrylate, 2-ethylhexyl acrylate, and vinyl acetate is selected, a mixing ratio of these monomers can be suitably selected so that a glass transition temperature (Tg) of the copolymer is in the range from −1 to −50° C., more preferably, the glass transition temperature (Tg) is in the range from −30 to −50° C. and the viscosity of the emulsion is 4,000-20,000 mPa·s/30° C. with about 50% by weight solid content. At this time, an ethyl acetate, an acrylic acid, a methacrylic acid, or a maleic acid may be added to the aqueous medium to improve the sticking force to various materials. Various types of nonionic surfactants may be used for polymerization of the above-described polymerizable monomers and specific examples thereof include: polyoxyethylene alkyl ether and polyoxyethylene ester fatty acid. Further, various types of anionic surfactants may be used for polymerization of the above-described polymerizable monomers and specific examples thereof include: polyoxyethylene-alkylether sodium ethane sulfonate and acyl monosodium glutamate. Then, the acidity is adjusted to weak acidity (pH 4 to 6) to obtain the acrylic aqueous emulsion adhesive (A) with the solid content of 40 to 60% by weight.

Further, specific examples of the quaternary ammonium salt (B1) used as an acidic or weak acidic water-soluble cationic polymer (B) in the present invention include: alkyl trimethyl ammonium chloride, stearyl dimethyl benzyl ammonium chloride, and stearyl trimethyl ammonium chloride.

Further, specific examples of the monoaryl amine derivative represented by a general formula CH₂═CH—CH₂—NHR (wherein R represents an alkyl group with 1-18 carbon atoms, a substituted alkyl group, an aralkyl group, or a cycloalkyl group) or a polymer of the salts thereof (B2) used as the acidic or weak acidic water-soluble cationic polymer (B) in the present invention include: an arylamine polymer, an arylamine hydrochloride polymer, an arylamine sulfate polymer, an arylamine phosphate polymer, and N-methylarylamine polymer. Further, specific examples of the copolymer of the monoaryl amine derivative or a polymer of the salts thereof and a monomer having an unsaturated double bond which is polymerizable with the derivative or the polymer (B3) include: an arylamine-N-methylarylamine polymer and a hydrochloric acid, a phosphoric acid, and a sulfuric acid of the copolymer. Furthermore, among the copolymers exemplified in Japanese Laid-Open Patent Publication No. 2-80681, an aqueous solution of polycation having the molecular structure represented by formula (1) or (2), in particular, can be suitably used.

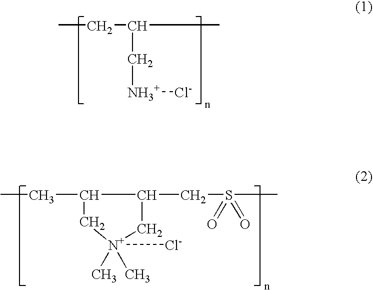

The acrylic aqueous emulsion adhesive (A) and the acidic or weak acidic water-soluble cationic polymer (B) can be mixed evenly without generation of agglutinate in the aqueous medium. This mixture is diluted to 20 to 50 times with the aqueous medium and the weak solution (M) is applied to an object to be colored with ink (dyeing, printing, painting, or the like) in advance by impregnation, coating, spraying, or the like, thereby drying the object to form the dried film of the ink-accepting layer forming material on the surface of the object. In the completed weak solution (M), that is, the ink-accepting layer forming material, it is preferable that the solid content of the acrylic aqueous emulsion adhesive is 0.5 to 5% by weight, the content of the water-soluble cationic polymer (B) is 0.1 to 3% by weight, and the rest is the aqueous medium.

Cloth, paper, wood, glass, plastic, stone, metal, or the like may be used as a base material of the object to be colored. The aqueous medium may be water. However, in order to increase the evaporation rate of the aqueous medium, 10 to 30% of alcohol such as ethyl alcohol, methyl alcohol, or the like may be added to the water.

It was confirmed by either visual observation or microscopic observation that a film was formed on any one of the above-described object to be colored by adsorbing emulsion particles in the weak solution onto the surface of the object at the moment of dipping the object into the weak solution to form a film. When the object to be colored is formed of various types fibers, the emulsion particles in the weak solution is excellent in penetrability and has a property of forming a film on the surface of a single fiber. Accordingly, when the object to be colored is dried to evaporate water in the weak solution after the formation of the film, a very thin transparent film having an even thickness is formed on the surface of the object to be colored. Further, when the object to be colored is formed of various types of fibers, a film covering the surface of each single fiber may also be formed. Further, this film adheres strongly to any one of the above-described objects to be colored and also to a low-adherent object such as PP or PE and a surface of a sheet subjected to water-repellent treatment.

When ink-jet printing is carried out on the object to be colored whereon the above-described film is formed, ink dots are absorbed into the film and fixed therein at the moment of adhesion of the ink dots to the film when the components of the water-base ink are either dyes or pigments. Accordingly, it is possible to obtain a print without color bleeding which is excellent in ink fixation, sharpness of an image, waterfastness, climatefastness, and color development.

The print thus obtained can be used immediately after the ink is dried. Slight stickiness however sometimes remain in the region where the ink is not adhered to the surface of the film. Accordingly, when the film after printing is heated to 80 to 100° C. by using high-temperature water heated to 80 to 100° C., steam, or hot wind, the film is stabilized and, in particular, the stickiness is removed from the region where the ink is not deposited so that the touch of the film is improved and the film is prevented from being stained. Furthermore, the surface whereto the ink is adhered becomes smooth and glossy with good color development.

Upon comparison of printing on the film formed of the mixture of the acrylic aqueous emulsion adhesive (A) and the water-soluble cationic polymer (B) to printing on the film formed of only the acrylic aqueous emulsion adhesive (A), it was confirmed that the film formed of the mixture of the acrylic aqueous emulsion adhesive (A) and the water-soluble cationic polymer (B) was excellent in all of ink fixation, sharpness of an image, waterfastness, climatefastness, and color development.

Furthermore, a coloring material (C) containing at least a dye, an inorganic pigment, an organic pigment, and a functional colorant may further contain a fragrance, a deodorizer, a medicinal agent, or the like in the water-base ink composition (N) made of the mixture of the acrylic aqueous emulsion adhesive (A), the water-soluble cationic polymer (B), and the coloring material (C). Furthermore, the coloring material (C) may also contain glossy metal powder for a metallic effect.

At the time of preparing the water-base ink composition made of the mixture of the acrylic aqueous emulsion adhesive (A) having a solid content of 40 to 50% by weight, the water-soluble cationic polymer (B), and the coloring material (C) containing at least a dye, an inorganic pigment, an organic pigment, and a functional colorant, the acrylic aqueous emulsion adhesive (A) is desirably mixed with the water-soluble cationic polymer (B) and the coloring material (C) without being diluted with the aqueous medium (D). In this case, either the water-soluble cationic polymer (B) or the coloring material (C) may be mixed first with the acrylic aqueous emulsion adhesive (A). Thereafter, the solution is desirably diluted to 20 to 40 times with the aqueous medium (D). When the acrylic aqueous emulsion adhesive (A) is diluted with the aqueous medium (D) in advance and then the water-soluble cationic polymer (B) and the coloring material (C) are mixed therewith, the coloring material (C) is agglutinated. Further, when the mixture of the acrylic aqueous emulsion adhesive (A) and the water-soluble cationic polymer (B) is diluted with the aqueous medium (D) in advance and then the coloring material (D) is mixed therewith, the coloring material (C) is also agglutinated.

When the water-base ink composition (N) prepared by the above-described method in a method such as printing, coating, painting, or the like on cloth, paper, wood, glass, plastic, stone, metal, hair, or the like is used, it is possible of obtaining a colored object without color bleeding which is excellent in ink fixation, sharpness of an image, waterfastness, climatefastness, and color development. Accordingly, when this water-base ink composition (N) is used as ink for ink-jet printing, it is possible of obtaining a print without color bleeding in an ink-dot level which is excellent in ink fixation, sharpness of an image, waterfastness, climatefastness, and color development.

Further, when the water-base ink composition (N) was coated on hair, it was confirmed that a dye or a pigment is introduced into the cuticle of the hair by the penetration effect of the acrylic aqueous emulsion adhesive (A). Accordingly, it was found that an equal coloring effect to hair dyeing using a general dye could be attained by the use of the water-base ink composition (N).

It was found, by visual observation and microscopic observation, that water is dispersed around the ingredients of the ink at the moment of adhesion of the water-base ink composition (N) to any one of the above-described object to be colored and, on the other hand, emulsion particles whereto the ingredients of the ink are bonded are not scattered around, but adsorbed onto the surface of the object to be colored (onto the surface of a single fiber when cloth formed of various types of fibers or paper is used), thereby forming a color film.

Since the water-base ink composition (N) further has a strong adhesion to a wet surface of an object to be colored, it is possible of printing or coating the water-base ink composition (N) on a wet surface of an object to be colored without flowing out of a color.

Furthermore, the water-base ink composition (N) strongly adheres to a low-adherent object such as PP or PE and a surface of a sheet subjected to water-repellent treatment so as to form a printed or coated surface which is excellent in ink fixation, sharpness of an image, waterfastness, climatefastness, and color development.

The printed, coated, or colored object thus obtained using the water-base ink composition (N) can be used immediately after the ink is dried. Thereafter, when the ink film is heated to 80 to 100° C. by using high-temperature water heated to 80 to 100° C., steam, or hot air, the ink film is stabilized and the stickiness is removed so that a smooth touch can be achieved, at the same time, the surface of the ink film is hardly stained, and moreover, the surface of the ink film is smooth, glossy, and has good color development.

Upon comparison of water-base ink composition (N) made of the mixture of the acrylic aqueous emulsion adhesive (A), the water-soluble cationic polymer (B), and the coloring material (C) to the water-base ink composition made of the mixture of only the acrylic aqueous emulsion adhesive (A) and the coloring material (C), it was confirmed that the water-base ink composition (N) made of the mixture of the acrylic aqueous emulsion adhesive (A), the water-soluble cationic polymer (B), and the coloring material (C) is more excellent in all of ink fixation, sharpness of an image, waterfastness, climatefastness, and color development. Although the reason of this has not been cleared, it is assumed that the water-soluble cationic polymer (B) strengthens the fixation of the coloring material (C) to the acrylic aqueous emulsion adhesive (A) and, at the same time, strengthens the fixation of the acrylic aqueous emulsion adhesive (A) to the surface of the object to be colored.

Further, it was confirmed, by observation using a microscope of 10,000 magnifications, that the water-base ink composition (N) made of the mixture of the acrylic aqueous emulsion adhesive (A), the water-soluble cationic polymer (B), and the coloring material (C) forms a molecular film of the adhesive (A), which is very thin as about 500 nm, on the surface of an object to be colored, for example, the surface of a single fiber, whereas the molecules of the adhesive (A) are well arranged to form the film. Furthermore, it was confirmed that a thin film of a pigment or a dye was formed on the molecular film of the adhesive (A).

### INDUSTRIAL APPLICABILITY

As is clear from the above description, according to the present invention, it is possible of providing an ink-accepting layer forming material capable of imparting a printing suitability to various base materials together with excellent sharpness of an image, waterfastness, climatefastness, and color development by using either of dye ink or pigment ink, and moreover, to soft base materials while maintaining the texture and flexibility thereof together with excellent sharpness of an image, waterfastness, climatefastness, and color development.

Further, according to the present invention, it is possible of providing a water-base ink composition usable for printing, painting, or the like on various base materials together with excellent sharpness of an image, waterfastness, climatefastness, and color development, and moreover, for printing, painting, or the like on soft paper, cloth hair, or the like while maintaining the texture and flexibility thereof together with excellent sharpness of an image, waterfastness, climatefastness, and color development.

1. An ink-accepting layer forming material to be applied in advance to an ink-accepting surface of an object that is to be colored with ink containing an anionic coloring material, said ink-accepting layer forming material comprising:
a weak acidic acrylic aqueous emulsion adhesive obtained by copolymerizing one or more ester (meth)acrylates having an alkyl group with 4-12 carbon atoms and a vinyl monomer;
a water-soluble cationic polymer; and
an aqueous medium, wherein
said acrylic aqueous emulsion adhesive has a viscosity of 4,000-20,000 mPa×s/30° C. when it is in an emulsion state with about 50% solid content, and a dried film of said acrylic aqueous emulsion adhesive has a glass transition temperature within the range from −10 to −50° C.,

2. An ink-accepting layer forming material according to claim 1, wherein said acrylic aqueous emulsion adhesive is obtained by copolymerizing one or more ester (meth)acrylates having an alkyl group with 4-12 carbon atoms and a vinyl monomer under presence of a noninic surfactant.

3. An ink-accepting layer forming material according to claim 1, wherein said acrylic aqueous emulsion adhesive is obtained by copolymerizing one or more ester (meth)acrylates having an alkyl group with 4-12 carbon atoms under presence of a nonionic surfactant and an anionic surfactant.

4. An ink-accepting layer forming material according to claim 1, 2, or 3, wherein a solid content of said acrylic aqueous emulsion adhesive is 0.5 to 5% by weight, a content of said water-soluble cationic polymer is 0.1 to 3% by weight, and the rest is an aqueous medium.

5. An ink-accepting layer forming material according to claim 1, 2, or 3, wherein said acrylic aqueous emulsion adhesive has an average molecular weight within the range from 3,000 to 20,000 and a weight-average molecular weight within the range from 10,000 to 100,000.

6. An ink-accepting layer forming material according to claim 1, 2, or 3, wherein said acrylic aqueous emulsion adhesive has a mean particle diameter within a range from 0.1 to 3 μm.

7. An ink-accepting layer forming material according to claim 1, 2, or 3, wherein a minimum forming temperature of a dried film of said acrylic aqueous emulsion adhesive is not more than 0° C.

8. An ink-accepting layer forming material according to claim 1, 2, or 3, wherein said acrylic aqueous emulsion adhesive is obtained by emulsion-copolymereization of 2-ethylhexyl acrylate, butyl acrylate, and vinyl acetate.

9. An ink-accepting layer forming material according to claim 8, wherein a content of said vinyl acetate in said acrylic aqueous emulsion adhesive is in the range from 20 to 30% by weight on the basis of a whole copolymer.

10. An ink-accepting layer forming material according to claim 1, wherein said water-soluble cationic polymer is a polymer of quaternary ammonium salts.

11. An ink-accepting layer forming material according to claim 1, wherein said water-soluble cationic polymer comprises a monoarylamine derivative represented by a general formula CH₂═CH—CH₂—NHR (wherein R represents an alkyl group with 1-18 carbon atoms, a substituted alkyl group, an aralkyl group, or a cycloalkyl group) or a polymer of salts thereof, or a copolymer of said monoarylamine derivative or a polymer of salts thereof and a monomer having an unsaturated double bond, which is copolymerizable with said derivative or said polymer.

12. An ink-accepting layer forming material according to claim 1 or 11, wherein said water-soluble cationic polymer is a polyarylamine hydrochloride having a weight-average molecular weight within a range from 1,000 to 5,000.

13. An ink-accepting layer forming material according to claim 1, 2, or 3, further comprising an aqueous emulsion of a weak acidic modified silicon resin having a nonionic or weak anionic particle charge.

14. An ink-accepting layer forming material according to claim 1, 2, or 3, further comprising an aqueous emulsion of a weak acidic fluorine resin having a nonionic or weak anionic particle charge.

15. An ink-accepting layer forming material according to claim 1, 2, or 3, further comprising an aqueous emulsion of a weak acidic polylactic acid having a nonionic or weak anionic particle charge.

16. An ink-accepting layer forming material according to claim 1, 2, or 3, wherein said anionic coloring material has an anionic group.

17. An ink-accepting layer forming material according to claim 16, wherein said anionic coloring material is one selected from a group consisting of a pigment, a functional colorant, a direct dye, an acid dye, and reactive dye.

18. An object that is to be colored obtained by applying an ink-accepting layer forming material according to any one of claims 1, 2, 3, 10 or 11, on an ink-accepting surface of a base material to be colored with ink containing an anionic coloring material and drying a film of said ink-accepting layer forming material.

19. A method of forming an ink-accepting layer forming material, wherein an ink-accepting layer forming material according to any one of claims 1, 2, 3, 10, or 11, is applied to an ink-accepting surface of a base material to be colored with ink containing an anionic coloring material; and a step of applying said ink-accepting layer forming material to said ink-accepting surface of said base material to be colored to form a dried film of said ink-accepting layer forming material is repeated for a plurality of times.

20. An object that is to be colored according to claim 18, wherein said base material to be colored is selected from a group consisting of a natural or synthetic resin; a natural, synthetic, or mixed fiber; cloth formed of a natural, synthetic, or mixed fiber; paper; wood; leather; synthetic leather; glass; a shell; a stone; and a metal, which can be used alone or as a composite material of two or more.

21. A coloring method, wherein ink containing an anionic coloring material is applied to an object that is to be colored according to claim 18, by one method selected from a group consisting of dip dyeing, printing, ink-jet printing, laser printer printing, coating, and spraying.

22. A water-base ink comprising:
a weak acidic acrylic aqueous emulsion adhesive obtained by copolymerizing one or more ester (meth)acrylates having an alkyl group with 4-12 carbon atoms and a vinyl monomer;
a water-soluble cationic polymer;
an anionic coloring material; and
an aqueous medium, wherein
said acrylic aqueous emulsion adhesive has a viscosity of 4,000-20,000 mPa·s/30° C. when it is an emulsion state with about 50% solid content, and a dried film of said acrylic aqueous emulsion adhesive has a glass transition temperature within the range from −10 to −50° C.

23. Water-base ink according to claim 22, wherein said acrylic aqueous emulsion adhesive is obtained by copolymerizing one or more ester (meth)acrylates having an alkyl group with 4-12 carbon atoms under presence of a nonionic surfactant.

24. Water-base ink according to claim 22, wherein said acrylic aqueous emulsion adhesive is obtained by copolymerizing one or more ester (meth)acrylates having an alkyl group with 4-12 carbon atoms under presence of a nonionic surfactant and an anionic surfactant.

25. Water-base ink according to claim 22, 23, or 24, wherein a solid content of said acrylic aqueous emulsion adhesive is 0.2 to 3% by weight, a content of said water-soluble cationic polymer is 0.1 to 3% by weight, a content of said anionic coloring material is 1 to 5% by weight, and the rest is an aqueous medium.

26. Water-base ink according to claim 22, 23, or 24, wherein said acrylic aqueous emulsion adhesive has an average molecular weight within a range from 3,000 to 20,000 and a weight-average molecular weight thereof within a range from 10,000 to 100,000.

27. Water-base ink according to claim 22, 23, or 24, wherein said acrylic aqueous emulsion adhesive has a mean particle diameter within a range from 0.1 to 3 μm.

28. Water-base ink according to claim 22, 23, or 24, wherein a minimum forming temperature of a dried film of said acrylic aqueous emulsion adhesive is not more than 0° C.

29. Water-base ink according to claim 22, 23, or 24, wherein said acrylic aqueous emulsion adhesive is obtained by emulsion copolymerization of 2-ethylhexyl acrylate, butyl acrylate, and vinyl acetate.

30. Water base ink according to claim 29, wherein a content of a vinyl acetate in said acrylic aqueous emulsion adhesive on the basis of a whole copolymer is 20 to 30% by weight.

31. Water-base ink according to claim 22, wherein said water-soluble cationic polymer is a polymer of quaternary ammonium salts.

32. Water-base ink according to claim 22, wherein said water-soluble cationic polymer comprises a monoarylamine derivative represented by a general formula CH₂═CH—CH₂—NHR (wherein R represents an alkyl group with 1-18 carbon atoms, a substituted alkyl group, an aralkyl group, or a cycloalkyl group) or a polymer of salts thereof, or a copolymer of said monoarylamine derivative or a polymer of salts thereof and a monomer having an unsaturated double bond, which is copolymerizable with said derivative or said polymer.

33. Water-base ink according to claim 22 or 32, wherein said water-soluble cationic polymer is a polyarylamine hydrochloride having a weight-average molecular weight within a range from 1,000 to 5,000.

34. Water-base ink according to claim 22, 23, or 24, further comprising an aqueous emulsion of a weak acidic modified silicone resin having a nonionic or weak anionic particle charge.

35. Water-base ink according to claim 22, 23, or 24, further comprising an aqueous emulsion of a weak acidic fluorine resin having a nonionic or weak anionic particle charge.

36. Water-base ink according to claim 22, 23, or 24, further comprising an aqueous emulsion of weak acidic polylactic acid having a nonionic or weak anionic particle charge.

37. Water-base ink according to claim 22, 23, or 24, wherein said anionic coloring material has an anionic group.

38. Water-base ink according to claim 37, wherein said anionic coloring material is at least one selected from a group consisting of a pigment, a functional colorant, a direct dye, an acid dye, and a reactive dye.

39. An object that is to be colored by applying water-base ink according to any one of claims 22, 23 or 24 to an ink-accepting surface of a base material to be colored.

40. An object to be colored according to claim 39, wherein said base material is selected from a group consisting of cloth formed of a natural fiber, cloth formed of a synthetic fiber, cloth formed of a mixed fiber, paper, wood, leather, synthetic leather, glass, a stone, a metal, and plastic.

41. A coloring method, wherein water-base ink according to any one of claims 22, 23 or 24, is applied to an ink-accepting surface of a base material to be colored by one method selected from a group consisting of dip dyeing, printing, ink-jet printing, laser printer printing, coating, and spraying.

42. A coloring method according to claim 41, wherein said base material to be colored is selected from a group consisting of a natural or synthetic resin; a natural, synthetic, or mixed fiber; cloth formed of a natural, synthetic, or mixed fiber; paper; wood; leather; synthetic leather; glass; a shell; a stone; and a metal, which can be used alone or as a composite material of two or more.

43. An ink-accepting layer forming material according to claim 13, further comprising an aqueous emulsion of a weak acidic fluorine resin having a nonionic or weak anionic particle charge.

44. An ink-accepting layer forming material according to claim 13, further comprising an aqueous emulsion of a weak acidic polylactic acid having a nonionic or weak anionic particle charge.

45. An ink-accepting layer forming material according to claim 14, further comprising an aqueous emulsion of a weak acidic polylactic acid having a nonionic or weak anionic particle charge.

46. A coloring method, wherein ink containing an anionic coloring material is applied to an object that is to be colored according to claim 19, by one method selected from a group consisting of dip dyeing, printing, ink-jet printing, laser printer printing, coating, and spraying.

47. A coloring method, wherein ink containing an anionic coloring material is applied to an object that is to be colored according to claim 20, by one method selected from a group consisting of dip dyeing, printing, ink-jet printing, laser printer printing, coating, and spraying.

48. Water-base ink according to claim 34, further comprising an aqueous emulsion of a weak acidic fluorine resin having a nonionic or weak anionic particle charge.

49. Water-base ink according to claim 34, further comprising an aqueous emulsion of weak acidic polylactic acid having a nonionic or weak anionic particle charge.

50. Water-base ink according to claim 35, further comprising an aqueous emulsion of weak acidic polylactic acid having a nonionic or weak anionic particle charge.

51. An object that is to be colored according to claim 19, wherein said base material to be colored is selected from a group consisting of a natural or synthetic resin; a natural, synthetic, or mixed fiber; cloth formed of a natural, synthetic, or mixed fiber; paper; wood; leather; synthetic leather; glass; a shell; a stone; and a metal, which can be used alone or as a composite material of two or more.
